(19) United States
(12) Patent Application Publication
(10) Pub. No.: US 2026/0287979 A1
(43) Pub. Date: Sep. 24, 2026

(54) CAMERA MODULE

(71) Applicant: SAMSUNG ELECTRO-MECHANICS CO., LTD., Suwon-si (KR)

(72) Inventor: Jung Woo KIM, Suwon-si (KR)

(73) Assignee: SAMSUNG ELECTRO-MECHANICS CO., LTD., Suwon-si (KR)

(21) Appl. No.: 19/556,195

(22) Filed: Mar. 4, 2026

(30) Foreign Application Priority Data
Mar. 21, 2025 (KR) 10-2025-0036460
Nov. 13, 2025 (KR) 10-2025-0171829

(51) Int. Cl. G03B 17/17

(52) U.S. Cl. CPC G03B 17/17

(57) ABSTRACT

A camera module includes a housing, a reflective member disposed on the housing, and configured to rotate about a first rotation axis and a second rotation axis perpendicular to the first rotation axis, a first ball member including a plurality of ball members disposed to be spaced apart from each other in a direction of the first rotation axis, and a second ball member including a plurality of ball members disposed to be spaced apart from each other in a direction of the second rotation axis. The first ball member and the second ball member are disposed between the reflective member and the housing. When viewed in a direction perpendicular to both the first rotation axis and the second rotation axis, the second ball member overlaps the reflective member.

### CROSS-REFERENCE TO RELATED APPLICATIONS

This application claims the benefit under 35 USC §119(a) of Korean Patent Application No. 10-2025-0036460 filed on Mar. 21, 2025, and Korean Patent Application No. 10-2025-0171829 filed on Nov. 13, 2025, in the Korean Intellectual Property Office, the entire disclosures of which are incorporated herein by reference for all purposes.

### BACKGROUND

### 1. Field

The following description relates to a camera module.

### 2. Description of Related Art

Cameras are typically implemented in portable electronic devices. When a camera is implemented in a smartphone, the camera may include an auto focus (AF) operation and an optical image stabilization (OIS) operation.

The optical image stabilization operation may be implemented in a manner such as moving a lens in a direction, perpendicular to an optical axis, or rotating a reflective member using an axis, perpendicular to the optical axis, as a rotation axis.

However, when a lens is disposed in front of a reflective member or when the reflective member has refractive power, resolution degradation may occur during the above-described image stabilization operation.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a camera module includes a housing; a reflective member disposed on the housing, and configured to rotate about a first rotation axis and a second rotation axis perpendicular to the first rotation axis; a first ball member comprising a plurality of ball members disposed to be spaced apart from each other in a direction of the first rotation axis; and a second ball member comprising a plurality of ball members disposed to be spaced apart from each other in a direction of the second rotation axis, wherein the first ball member and the second ball member are disposed between the reflective member and the housing, and wherein when viewed in a direction perpendicular to both the first rotation axis and the second rotation axis, the second ball member overlaps the reflective member.

The reflective member may have a width in a direction parallel to the first rotation axis, and a length in a direction parallel to the second rotation axis.

A separation distance between the plurality of ball members includes in the second ball member may be less than the length of the reflective member.

The first ball member and the second ball member may be disposed at different heights in a direction perpendicular to both the first rotation axis and the second rotation axis, and the first rotation axis and the second rotation axis may not intersect each other.

The camera module may include a folded module including the reflective member; and a lens module including a plurality of lenses disposed in an optical axis direction, and configured to move in the optical axis direction, wherein the first rotation axis may be parallel to the optical axis direction.

The folded module may include a reflective member holder on which the reflective member is mounted; and a rotation guide on which the reflective member holder is supported, and the reflective member holder may be supported by the rotation guide with the first ball member interposed between the reflective member holder and the rotation guide, and the rotation guide is supported by the housing with the second ball member interposed between the rotation guide and the housing.

The folded module may include a first driving unit comprises a first magnet disposed on the reflective member holder and a first coil disposed on the housing to oppose the first magnet; and a second driving unit comprising a second magnet disposed on the rotation guide and a second coil disposed on the housing to oppose the second magnet, and the first coil and the second coil may be mounted on a substrate and disposed on the housing.

The folded module may include a first sensing magnet disposed on the reflective member holder and spaced apart from the first magnet in a direction perpendicular to both the first rotation axis and the second rotation axis; and a second sensing magnet disposed on the rotation guide and spaced apart from the second magnet in a diagonal direction.

The camera module may include a first position sensor disposed on the housing to oppose the first sensing magnet; and a second position sensor disposed on the housing to oppose the second sensing magnet, wherein the first position sensor and the second position sensor may be mounted on the substrate together with the first coil and the second coil, and may be disposed on the housing.

The housing may include a step portion having a step in a direction perpendicular to the optical axis direction at a first corner portion of the housing adjacent to the second sensing magnet, and at a second corner portion of the housing, which is disposed to be spaced apart from the first corner portion in a direction of the second rotation axis, and the substrate may include an avoidance portion having a partially cut shape at a position corresponding to the step portion.

In a general aspect, a camera module includes a housing having an internal space; a folded module disposed in the internal space and comprising a reflective member; a lens module including a plurality of lenses arranged in an optical axis direction and disposed in the optical axis direction with respect to the folded module; and a shield can coupled to the housing and configured to cover the internal space, wherein the housing and the shield can comprise a step portion having a step in a direction perpendicular to the optical axis direction, the step being disposed at one corner portion among two corner portions of the housing and the shield can adjacent to the folded module.

The folded module may include a reflective member holder on which the reflective member is mounted; and a rotation guide on which the reflective member holder is supported, and the reflective member holder is configured to rotate about a first rotation axis parallel to the optical axis direction, and the rotation guide is configured to rotate about a second rotation axis perpendicular to the optical axis direction.

The folded module may include a first ball member disposed between the reflective member holder and the rotation guide; and a second ball member disposed between the rotation guide and the housing, and the first ball member and the second ball member may be disposed in a space between a reflective surface of the reflective member and a bottom surface of the housing.

The second ball member may include a plurality of ball members disposed to be spaced apart from each other in a direction of the second rotation axis, and the second ball member may be disposed at a position spaced apart from a center of the reflective member in a direction perpendicular to both the first rotation axis and the second rotation axis.

The second ball member may include a plurality of ball members disposed to be spaced apart from each other in a direction of the second rotation axis, and a separation distance between the plurality of ball members may be less than a length of the reflective member in the direction of the second rotation axis.

The camera module may further include a substrate disposed to surround side surfaces of the housing, wherein the substrate may include an avoidance portion having a partially cut shape at a position corresponding to the step portion of the housing.

Other features and aspects will be apparent from the following detailed description, the drawings, and the claims.

### BRIEF DESCRIPTION OF DRAWINGS

FIG. 1 illustrates a perspective view of an example camera module, in accordance with one or more embodiments.

FIG. 2 illustrates a perspective view of the example camera module of FIG. 1 from which a shield can is removed.

FIG. 3 illustrates an exploded perspective view of an example camera module, in accordance with one or more embodiments.

FIG. 4 illustrates a perspective view of a folded module, in accordance with one or more embodiments.

FIG. 5 illustrates an exploded perspective view of a folded module, in accordance with one or more embodiments.

FIG. 6 illustrates a bottom exploded perspective view of a folded module, in accordance with one or more embodiments.

FIG. 7 illustrates a cross-sectional view taken along line I–I’ of a folded module, in accordance with one or more embodiments.

FIG. 8 illustrates a cross-sectional view taken along line II–II’ of a folded module, in accordance with one or more embodiments.

FIG. 9 illustrates a view of an arrangement state of a driving unit of a folded module, in accordance with one or more embodiments.

FIG. 10 illustrates a view of positions of a first ball member and a second ball member, in accordance with one or more embodiments.

FIG. 11 illustrates a view of a state in which a shield can is coupled to a folded module, in accordance with one or more embodiments.

FIG. 12 illustrates a perspective view of a housing and a substrate, in accordance with one or more embodiments.

FIG. 13 illustrates a perspective view of a substrate, in accordance with one or more embodiments.

FIG. 14 illustrates an exploded perspective view of a lens module, in accordance with one or more embodiments.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as "first," "second," and "third", or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” "connected to," "coupled to," or "joined to" another component, element, or layer, it may be directly (e.g., in contact with the other component, element, or layer) “on,” "connected to," "coupled to," or "joined to" the other component element, or layer, or there may reasonably be one or more other components elements, or layers intervening therebetween. When a component or element is described as "directly on", "directly connected to," "directly coupled to," or "directly joined to" another component element, or layer, there can be no other components, elements, or layers intervening therebetween. Likewise, expressions, for example, "between" and "immediately between" and "adjacent to" and "immediately adjacent to" may also be construed as described in the foregoing.

The terminology used herein is for describing various examples only and is not to be used to limit the disclosure. The articles "a," "an," and "the" are intended to include the plural forms as well, unless the context clearly indicates otherwise. As non-limiting examples, terms "comprise" or "comprises," "include" or "includes," and "have" or "has" specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms "comprise" or "comprises," "include" or "includes," and "have" or "has" specify the presence of stated features, numbers, operations, members, elements, and/or combinations thereof, other embodiments may exist where one or more of the stated features, numbers, operations, members, elements, and/or combinations thereof are not present.

As used herein, the term "and/or" includes any one and any combination of any two or more of the associated listed items. The phrases "at least one of A, B, and C", "at least one of A, B, or C", and the like are intended to have disjunctive meanings, and these phrases "at least one of A, B, and C", "at least one of A, B, or C", and the like also include examples where there may be one or more of each of A, B, and/or C (e.g., any combination of one or more of each of A, B, and C), unless the corresponding description and embodiment necessitates such listings (e.g., "at least one of A, B, and C") to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

One or more examples may provide a camera module that has a structure suitable for miniaturization and provides high-quality image capture.

In accordance with the one or more examples, resolution degradation during an image stabilization operation may be prevented, and a volume of a module may be reduced.

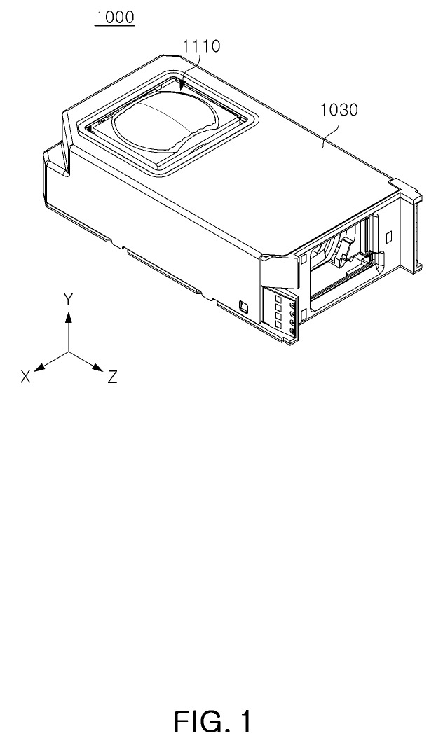

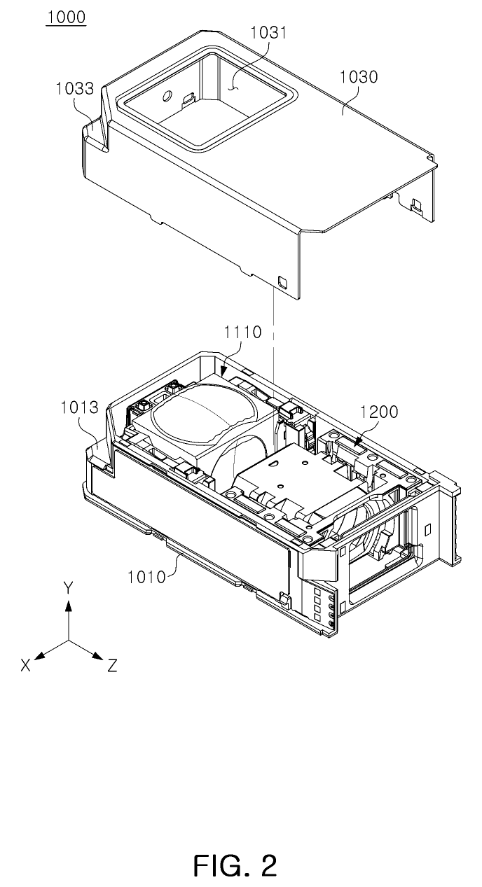

FIG. 1 illustrates a perspective view of an example camera module according to an example embodiment. FIG. 2 illustrates a perspective view of the example camera module of FIG. 1 from which a shield can is removed.

A camera module 1000 according to an example embodiment may include a housing 1010 having an internal space, a plurality of optical modules 1100 and 1200 disposed in the internal space, and a shield can 1030 coupled to the housing 1010 to cover the internal space. Additionally, a substrate 1040 on which a driving unit or the like is mounted may be attached to an external surface of the housing 1010, and an image sensor (not illustrated) may be disposed on one side of the housing 1010 in a length direction. Incident light may pass through the plurality of optical modules 1100 and 1200, may be incident on the image sensor, and may be converted into an electrical signal.

The plurality of optical modules 1100 and 1200 may be a folded module 1100 and a lens module 1200, respectively.

The folded module 1100 may be configured to change a traveling direction of light. For example, the folded module 1100 may include a reflective member 1110, and the reflective member 1110 may change a traveling direction of light incident in a first direction (Y-direction) to a second direction (Z-direction).

The lens module 1200 may include a plurality of lenses disposed in the second direction (Z-direction). An optical axis formed by the plurality of lenses may be parallel to the second direction (Z-direction). Accordingly, an optical axis direction (Z-axis direction) described in the one or more examples may refer to a direction, parallel to the second direction.

The shield can 1030 may be coupled to the housing 1010 to cover the internal space, thereby protecting the plurality of optical modules 1100 and 1200. However, the shield can 1030 may include an opening 1031 to allow incidence of light, and external light may be incident on the folded module 1100 through the opening 1031.

According to an example embodiment, the shield can 1030 may include a step portion 1033 at one corner thereof. The step portion 1033 may have a shape in which a portion of the one corner is cut away, and may have a height step, with respect to an upper surface of the shield can 1030 in which the opening 1031 is formed, in the first direction (Y-direction). The housing 1010 may also include, at one corner thereof, a step portion 1013 corresponding to the step portion 1033 of the shield can 1030.

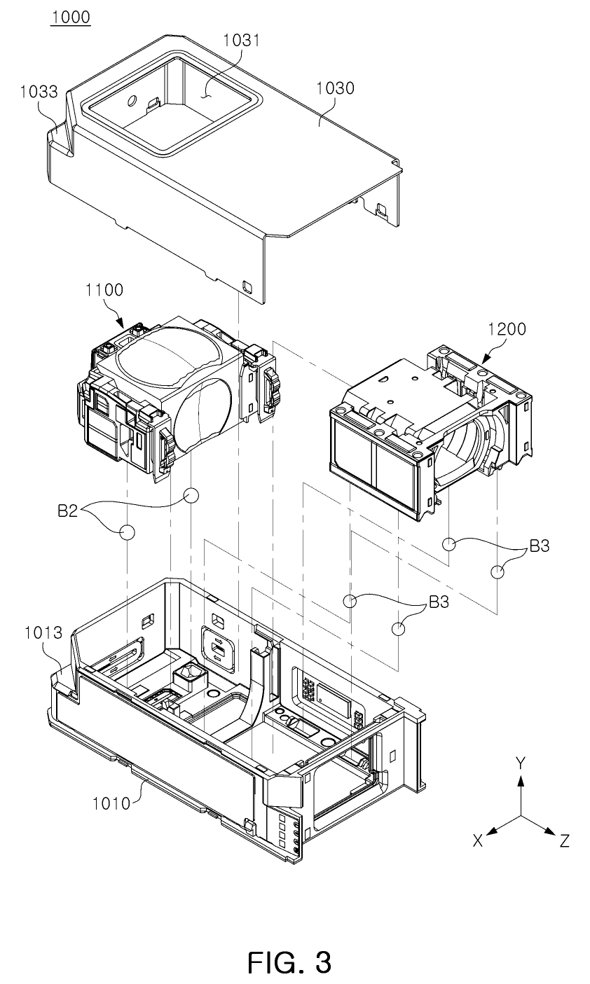

FIG. 3 is an exploded perspective view of an example camera module according to an example embodiment. Hereinafter, components included in the camera module 1000 according to an example embodiment will be described in detail with reference to FIG. 3 together with other drawings.

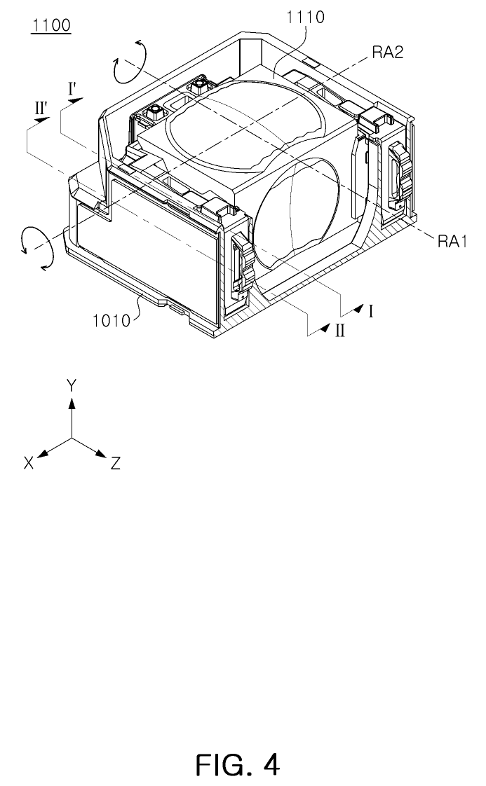

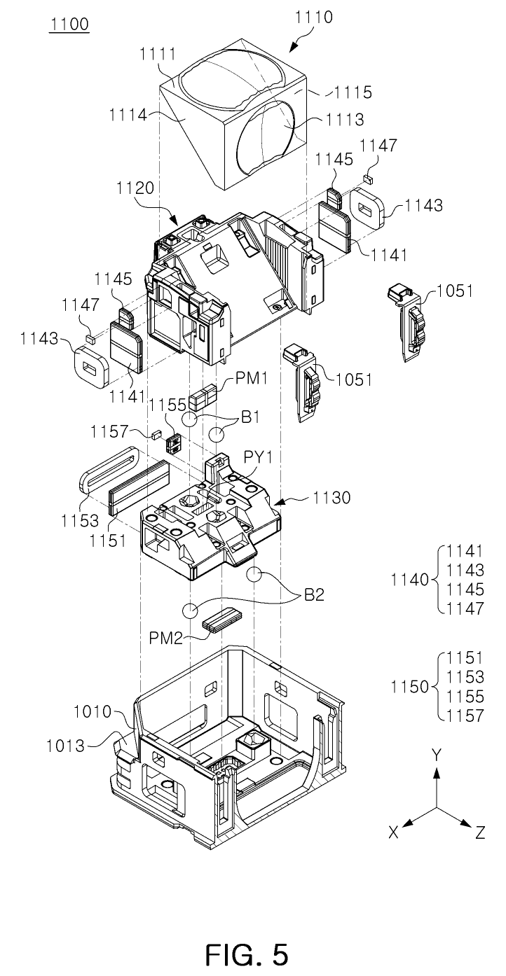

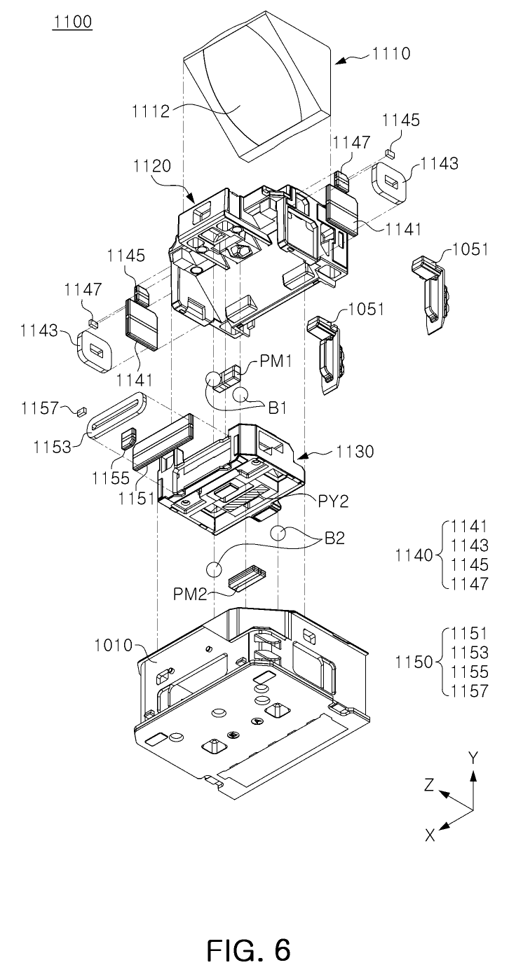

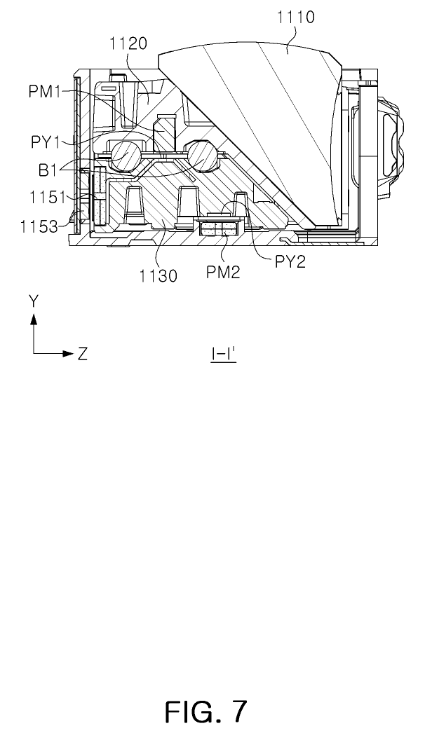

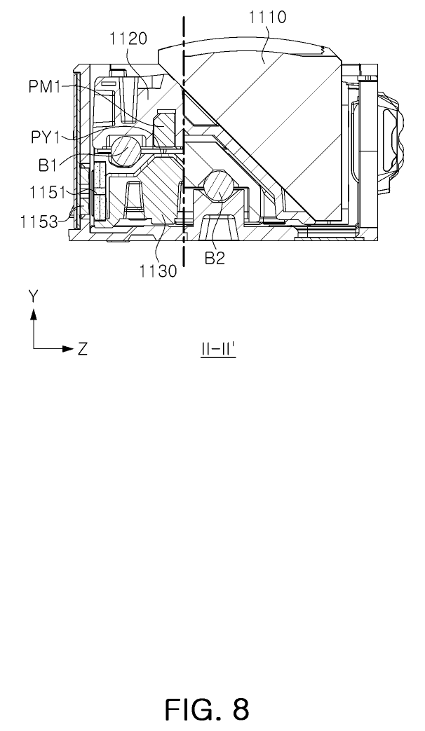

FIG. 4 illustrates a perspective view of a folded module according to an example embodiment. FIG. 5 is an exploded perspective view of a folded module according to an example embodiment. FIG. 6 is a bottom exploded perspective view of a folded module according to an example embodiment. FIG. 7 is a cross-sectional view taken along line I–I’ of a folded module according to an example embodiment. FIG. 8 is a cross-sectional view taken along line II–II’ of a folded module according to an example embodiment.

The folded module 1100 according to an example embodiment may include a reflective member 1110, a reflective member holder 1120, and a rotation guide 1130.

In an example embodiment, the reflective member 1110 may be a power prism that has refractive power and reflects light. For example, an incident surface 1111 and an exit surface 1113 of the reflective member 1110 may have curvature at least in a paraxial region thereof, thereby serving a role of a lens. A reflective surface 1112 may reflect light to change a traveling direction of the light. According to an example embodiment, the reflective member 1110 may converge light rays passing through the reflective member 1110. Accordingly, the reflective member 1110 may contribute to reducing a thickness of the camera module 1000.

In order to reduce a thickness of the camera module 1000 and to reduce a risk of damage, a corner at which the reflective surface 1112 and the exit surface 1113 of the reflective member 1110 meet may be processed into a D-cut shape.

According to an example embodiment, the folded module 1100 may perform an operation to stabilize an image during image capturing. The camera module 1000 may stabilize an image by rotating the reflective member 1110 about two axes perpendicular to each other. For example, the reflective member may rotate about an axis (hereinafter, a first rotation axis RA1), parallel to an optical axis (Z-axis), and an axis (hereinafter, a second rotation axis RA2), parallel to a first axis (X-axis) perpendicular to the optical axis (Z axis). According to an example embodiment, one of two rotation axes of the reflective member 1110 may be formed to be parallel to the optical axis (Z-axis), thereby minimizing resolution degradation during image stabilization.

The reflective member holder 1120 may be rotatably supported by the rotation guide 1130. For example, the reflective member holder 1120 may rotate with respect to the rotation guide 1130 about the first rotation axis RA1. The reflective member 1110 may be disposed on the reflective member holder 1120, and may rotate together with the reflective member holder 1120.

The rotation guide 1130 may be rotatably supported by the housing 1010. For example, the rotation guide 1130 may rotate with respect to the housing 1010 about the second rotation axis RA2. The reflective member holder 1120 may be disposed on the rotation guide 1130, and may rotate together with the rotation guide 1130. The reflective member 1110 may be disposed on the reflective member holder 1120, such that the reflective member 1110 may also rotate together therewith.

The folded module 1100 may include a first driving unit 1140 that provides a driving force to generate rotation about the first rotation axis RA1, and a second driving unit 1150 that provides a driving force to generate rotation about the second rotation axis RA2.

The first driving unit 1140 may include a first magnet 1141 and a first coil 1143. The first magnet 1141 may be disposed on two side surfaces of the reflective member holder 1120, and the first coil 1143 may be disposed on the housing 1010 to oppose the first magnet 1141. The first coil 1143 may be mounted on the substrate 1040.

The first magnet 1141 and the first coil 1143 may be disposed to oppose each other in a first axis (X-axis) direction. An N-pole (or an S-pole), a neutral region, and an S-pole (or an N-pole) may be sequentially disposed on one surface of the first magnet 1141, opposing the first coil 1143, in a second axis (Y-axis) direction. The second axis (Y-axis) direction may be a direction, perpendicular to both the optical axis (Z-axis) and the first-axis (X-axis).

A ball member B1 (hereinafter, a first ball member) may be disposed between the reflective member holder 1120 and the rotation guide 1130. The reflective member holder 1120 may be rotatably supported by the rotation guide 1130 with the first ball member B1 interposed therebetween.

The first ball member B1 may include a plurality of ball members that are spaced apart from each other in an optical axis (Z-axis) direction, and a virtual straight line connecting the first ball member B1 may be the first rotation axis RA1.

According to an example embodiment, a driving force for rotating the reflective member 1110 and the reflective member holder 1120 may be generated at a position spaced apart from the first rotation axis RA1, for example, in the vicinity of the two side surfaces of the reflective member holder 1120. Accordingly, when current is applied to the first coil 1143, rotational force to rotate the reflective member 1110 and the reflective member holder 1120 about the first rotation axis RA1 may be generated by electromagnetic interaction between the first magnet 1141 and the first coil 1143.

The first ball member B1 may be individually accommodated in accommodation grooves (not illustrated) formed in the reflective member holder 1120 and the rotation guide 1130. The first ball member B1 may support rotation of the reflective member 1110 and the reflective member holder 1120 while rotating in place in a state of being accommodated in the accommodation grooves. The first ball member B1 may be implemented in a modified form such as a hemispherical protrusion or the like.

The reflective member holder 1120 may include a damper DP protruding toward the shield can 1030. The damper DP may prevent collision between the reflective member holder 1120 and the shield can 1030 when the reflective member holder 1120 rotates about the first rotation axis RA1. Additionally, the damper DP may limit a rotation range of the reflective member holder 1120.

The folded module 1100 may include a first sensing magnet 1145 and a first position sensor 1147, sensing a position of the reflective member holder 1120. The first sensing magnet 1145 may be disposed on two side surfaces of the reflective member holder 1120 together with the first magnet 1141. The first position sensor 1147 may be mounted on the substrate 1040 together with the first coil 1143, and may be disposed on the housing 1010.

The first sensing magnet 1145 and the first position sensor 1147 may be disposed to oppose each other in the first axis (X-axis) direction. An S-pole (or an N-pole), a neutral region, and an N-pole (or an S-pole) may be sequentially disposed on one surface of the first sensing magnet 1145, opposing the first position sensor 1147, in the second axis (Y-axis) direction. The first sensing magnet 1145 and the first magnet 1141 may be disposed at positions spaced apart from each other in the second axis (Y-axis) direction, and may be disposed such that regions of the first sensing magnet 1145 and the first magnet 1141 having the same polarity are adjacent to each other.

The first position sensor 1147 may be disposed at a position spaced apart from the first coil 1143 to oppose the neutral region of the first sensing magnet 1145. The first position sensor 1147 may sense a position of the reflective member holder 1120 by sensing a change in a magnetic field occurring as the reflective member 1110 or the like rotates about the first rotation axis RA1. As an example, the first position sensor 1147 may be a Hall sensor.

The reflective member holder 1120 may be in close contact with the rotation guide 1130 in the second axis (Y-axis) direction with the first ball member B1 interposed therebetween. Force, pulling in the second axis (Y-axis) direction, may be applied to a space between the reflective member holder 1120 and the rotation guide 1130. In an example embodiment, a pulling magnet PM1 may be disposed on the reflective member holder 1120, and a pulling yoke PY1 may be disposed on the rotation guide 1130. The pulling magnet PM1 and the pulling yoke PY1 may be disposed to oppose each other in the second axis (Y-axis) direction, and may generate an attractive force in the second-axis (Y-axis) direction. Positions of the pulling magnet PM1 and the pulling yoke PY1 may be interchanged.

The second driving unit 1150 may include a second magnet 1151 and a second coil 1153. The second magnet 1151 may be disposed on one side surface of the rotation guide 1130, and the second coil 1153 may be disposed on the housing 1010 to oppose the second magnet 1151. The second coil 1153 may be mounted on the substrate 1040.

The second magnet 1151 and the second coil 1153 may be disposed to oppose each other in the optical axis (Z-axis) direction. An N-pole or an S-pole, a neutral region, and an S-pole or an N-pole may be sequentially disposed on one surface of the second magnet 1151, opposing the second coil 1153, in the second-axis (Y-axis) direction.

A ball member B2 (hereinafter, a second ball member) may be disposed between the rotation guide 1130 and the housing 1010. The rotation guide 1130 may be rotatably supported by the housing 1010 with the second ball member B2 interposed therebetween.

The second ball member B2 may include a plurality of ball members that are spaced apart from each other in the first axis (X-axis) direction, and a virtual straight line connecting the second ball member B2 may be the second rotation axis RA2.

According to an example embodiment, a driving force to rotate the reflective member 1110, the reflective member holder 1120, and the rotation guide 1130 may be generated at a position spaced apart from the second rotation axis RA2, for example, in the vicinity of one side surface of the rotation guide 1130. Accordingly, when current is applied to the second coil 1153, a rotational force to rotate the reflective member 1110, the reflective member holder 1120, and the rotation guide 1130 about the second rotation axis RA2 may be generated by an electromagnetic interaction between the second magnet 1151 and the second coil 1153.

The second ball member B2 may be individually accommodated in accommodation grooves (not illustrated) formed in the rotation guide 1130 and the housing 1010. The second ball member B2 may support rotation of the reflective member 1110, the reflective member holder 1120, and the rotation guide 1130 while rotating in place in a state of being accommodated in the accommodation grooves. The second ball member B2 may be implemented in a modified form such as a hemispherical protrusion or the like.

The camera module 1000 may include a stopper 1051 that is disposed on the housing 1010. The stopper 1051 may prevent a direct collision between injection-molded components while limiting a rotation range of the folded module 1100.

The stopper 1051 may include a damper that protrudes toward the reflective member holder 1120. The damper may oppose the reflective member holder 1120 in the second axis (Y-axis) direction and the optical axis (Z-axis) direction. Accordingly, when the folded module 1100 rotates about the first rotation axis RA1 and the second rotation axis RA2, the folded module 1100 may collide with the damper formed on the stopper 1051. The stopper 1051 may further include a damper that protrudes toward a lens carrier 1220 to be described below.

The folded module 1100 may include a second sensing magnet 1155 and a second position sensor 1157, which sense a position of the rotation guide 1130. The second sensing magnet 1155 may be disposed on one side surface of the rotation guide 1130 together with the second magnet 1151, and the second position sensor 1157 may be mounted on the substrate 1040 together with the second coil 1153, and may be disposed on the housing 1010.

The second sensing magnet 1155 and the second position sensor 1157 may be disposed to oppose each other in the optical axis (Z-axis) direction. An S-pole (or an N-pole), a neutral region, and an N-pole (or an S-pole) may be sequentially disposed on one surface of the second sensing magnet 1155, opposing the second position sensor 1157, in the second axis (Y-axis) direction. The second sensing magnet 1155 and the second magnet 1151 may be disposed at positions that are spaced apart from each other in the second axis (Y-axis) direction, and may be disposed such that regions of the second sensing magnet 1155 and the second magnet 1151 having the same polarity are adjacent to each other.

The second position sensor 1157 may be disposed at a position that is spaced apart from the second coil 1153 to oppose the neutral region of the second sensing magnet 1155. The second position sensor 1157 may sense a position of the rotation guide 1130 by sensing a change in a magnetic field occurring as the reflective member 1110 or the like rotates about the second rotation axis RA2. In a non-limited example, the second position sensor 1157 may be a Hall sensor.

The rotation guide 1130 may be in close contact with the housing 1010 in the second axis (Y-axis) direction with the second ball member B2 interposed therebetween. A force pulling in the second-axis (Y-axis) direction may be applied to a space between the rotation guide 1130 and the housing 1010. In an example embodiment, a pulling yoke PY2 may be disposed on the rotation guide 1130, and a pulling magnet PM2 may be disposed on the housing 1010. The pulling yoke PY2 and the pulling magnet PM2 may be disposed to oppose each other in the second axis (Y-axis) direction to generate an attractive force in the second axis (Y-axis) direction. Positions of the pulling yoke PY2 and the pulling magnet PM2 may be interchanged.

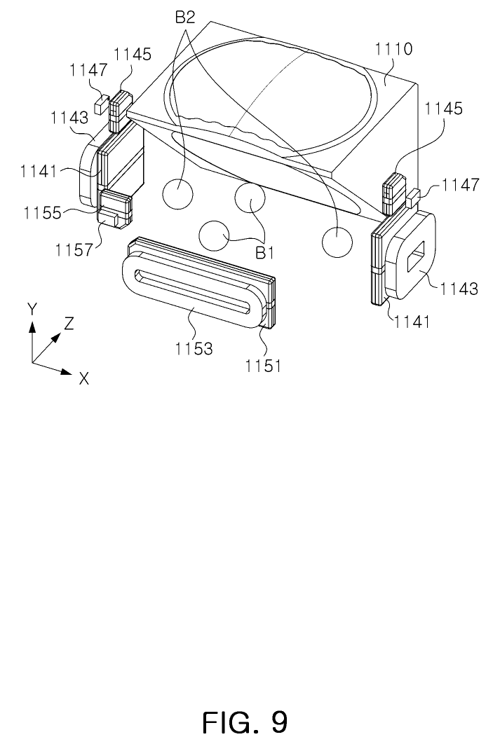

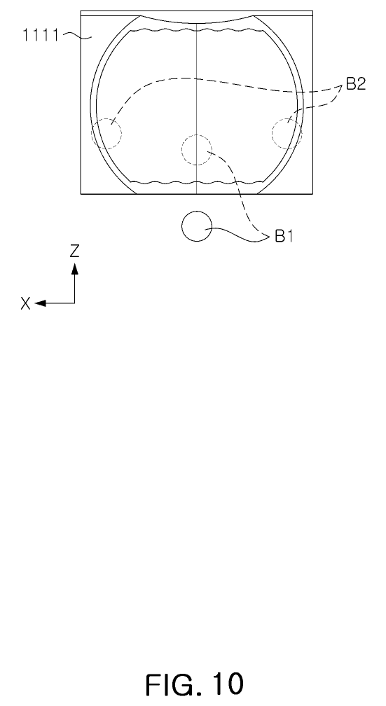

FIG. 9 is a view of an arrangement state of a driving unit of a folded module according to an example embodiment. FIG. 10 is a view of positions of a first ball member and a second ball member according to an example embodiment.

According to an example embodiment, the first ball member B1 and the second ball member B2 may be disposed in a space between the reflective surface 1112 of the reflective member 1110 and a bottom surface of the housing 1010. The first ball member B1 and the second ball member B2 may be disposed in a space between the reflective member 1110 and the housing 1010 to be spaced apart from each other in the second axis (Y-axis) direction. That is, the first ball member B1 and the second ball member B2 may be disposed at different heights in the second axis (Y-axis) direction. The first ball member B1 may form the first rotation axis RA1, and the second ball member B2 may form the second rotation axis RA2, such that the first rotation axis RA1 and the second rotation axis RA2 may not intersect each other.

The first ball member B1 may be disposed between the reflective member holder 1120 and the rotation guide 1130, and may include a plurality of ball members disposed to be spaced apart from each other in the optical axis direction (Z-axis direction). The second ball member B2 may be disposed between the rotation guide 1130 and the housing 1010, and may include a plurality of ball members disposed to be spaced apart from each other in the first axis (X-axis) direction. The first axis (X-axis) direction may correspond to a length direction of the incident surface 1111 of the reflective member 1110. In an example embodiment, a separation distance between the plurality of ball members in the first axis (X-axis) direction may be less than a length of the incident surface 1111 of the reflective member 1110 in the length direction. Accordingly, when viewed in the second axis (Y-axis) direction, the second ball member B2 may overlap the reflective member 1110. The first axis (X-axis) direction may also correspond to a direction in which two side surfaces 1114 and 1115 of the reflective member 1110, meeting the incident surface 1111, the reflective surface 1112, and the exit surface 1113, are spaced apart from each other. Accordingly, the separation distance between the plurality of ball members included in the second ball member B2 in the first axis (X-axis) direction may be less than a distance between the two side surfaces 1114 and 1115 of the reflective member 1110.

According to an example embodiment, both the first ball member B1 and the second ball member B2 may be disposed in the space between the reflective surface 1112 of the reflective member 1110 and the bottom surface of the housing 1010, thereby reducing a size of the camera module 1000 in the first axis (X-axis) direction.

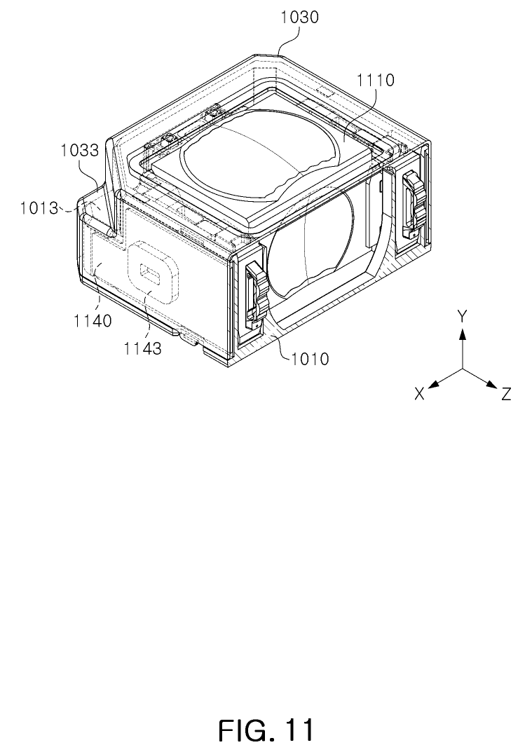

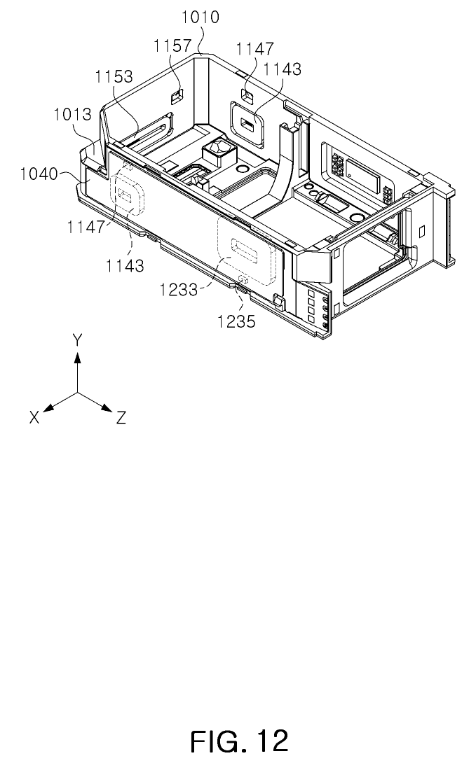

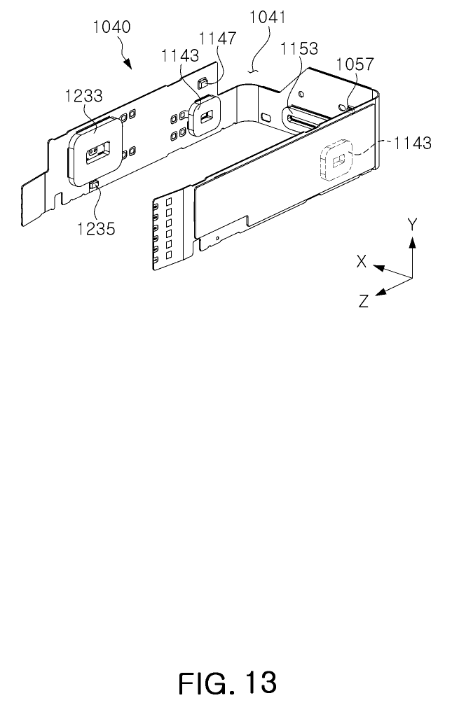

FIG. 11 is a view of an example in which a shield can is coupled to a folded module according to an example embodiment. FIG. 12 is a perspective view of a housing and a substrate according to an example embodiment. FIG. 13 is a perspective view of a substrate according to an example embodiment.

As described above, according to an example embodiment, the shield can 1030 and the housing 1010 may include step portions 1033 and 1013 disposed at one corner portion of the shield can 1030 and the housing 1010 respectively. According to an example embodiment, the second ball member B2 may be disposed to be closer to the bottom surface of the housing 1010 than the shield can 1030 in the second axis (Y-axis) direction, such that a free space may be formed in the internal space of the housing 1010 in which the folded module 1100 is disposed. Accordingly, in order to further reduce the size of the camera module 1000, the step portions 1033 and 1013 may be formed at one corner portion of the shield can 1030 and the housing 1010, forming the exterior of the camera module 1000. For example, the step portion 1033 of the shield can 1030 may have a shape in which a portion of one corner portion of the shield can 1030 is cut, and the step portion 1013 of the housing 1010 may have a shape corresponding to that of the step portion 1033 of the shield can 1030.

The substrate 1040 on which a driving unit or the like is mounted may be attached to the external surface of the housing 1010. The substrate 1040 may be a flexible printed circuit board (FPCB), and may be bent at a corner portion at which two adjacent side surfaces of the housing 1010 meet, such that the substrate 1040 may extend across the side surfaces of the housing 1010. A coil or the like which is involved in the driving of the folded module 1100 and the lens module 1200, may be mounted on the substrate 1040, and the coil or the like may be exposed to the internal space of the housing 1010 through a through-hole formed in the side surface of the housing 1010.

According to an example embodiment, the substrate 1040 may include an avoidance portion 1041 at a position corresponding to the position of the step portion 1013 of the housing 1010. For example, the step portion 1013 may be formed at a corner portion at which two adjacent side surfaces of the housing 1010 meet, the avoidance portion 1041 may be formed in a bent portion of the substrate 1040.

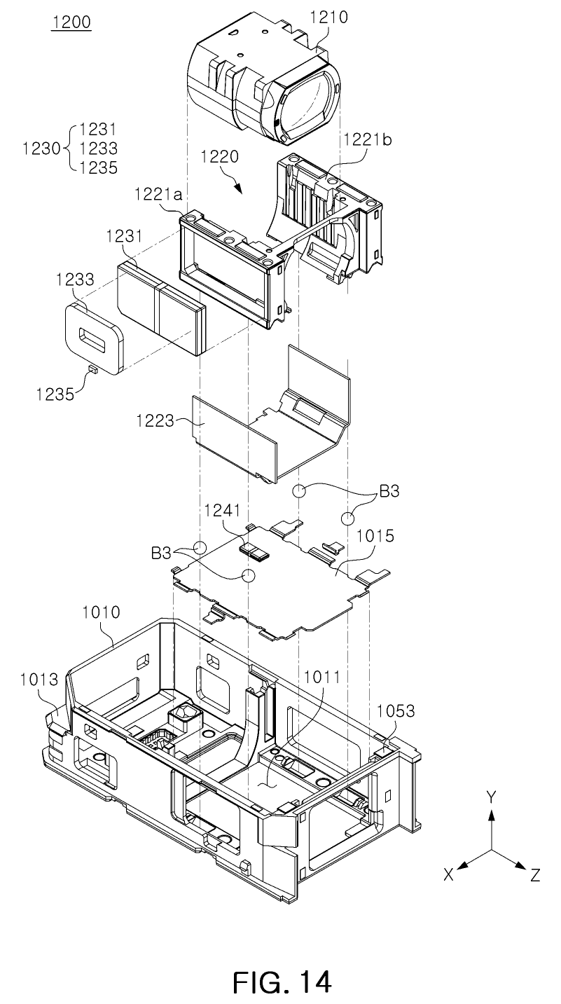

FIG. 14 illustrates an exploded perspective view of an example lens module according to an example embodiment.

According to an example embodiment, the lens module 1200 may include a lens barrel 1210 on which a plurality of lenses L are mounted, and a lens carrier 1220 to which the lens barrel 1210 is coupled.

The lens carrier 1220 may include two side surfaces 1221a and 1221b spaced apart from each other with the lens barrel 1210 disposed therebetween, and an insert member 1223 disposed between the two side surfaces 1221a and 1221b, the insert member 1223 forming a bottom surface of the lens carrier 1220. The insert member 1223 may be disposed to overlap the lens barrel 1210 in the second axis (Y-axis) direction corresponding to a thickness direction of the camera module 1000.

According to an example embodiment, the two side surfaces 1221a and 1221b of the lens carrier 1220 may be formed of a plastic material, and the insert member 1223 may be formed of a metal material. The metal material may have a strength that is greater than a strength of the plastic material. Accordingly, when the insert member 1223 forms the bottom surface of the lens carrier 1220, a height of the camera module 1000 may be reduced while maintaining structural rigidity. Additionally, a lens having a large diameter may be used without increasing the height of the camera module 1000.

The lens carrier 1220 may be manufactured using an insert molding method. That is, the two side surfaces 1221a and 1221b of the lens carrier 1220 and the insert member 1223 may be integrally formed. Although not described in detail, the insert member 1223 may further include portions disposed on the inside of the two side surfaces 1221a and 1221b of the lens carrier 1220, in addition to a portion forming the bottom surface of the lens carrier 1220.

Additionally, according to an example embodiment, the housing 1010 may include an insert member 1015 that forms a bottom surface of the internal space in which the lens carrier 1220 is disposed. For example, the bottom surface of the housing 1010 may include an opening 1011, and the insert member 1015 may be disposed in the opening 1011 to form the bottom surface of the housing 1010.

The insert member 1015 may be formed of a metal material for the same purpose as the insert member 1223 forming the bottom surface of the lens carrier 1220 described above. In particular, according to an example embodiment, the lens barrel 1210 may overlap the insert members 1223 and 1015, formed of a metal material, in the second axis (Y-axis) direction instead of a plastic insert-molded component, such that the above-described effect may be maximized.

The housing 1010 may also be manufactured using an insert molding method.

According to an example embodiment, the lens module 1200 may perform an operation to focus on a subject. The camera module 1000 may adjust focus by moving the plurality of lenses L in the optical axis (Z-axis) direction.

The lens carrier 1220 may be movably supported by the housing 1010. In an example, the lens carrier 1220 may be movably supported by the housing 1010 in the optical axis (Z-axis) direction. The lens barrel 1210 may be coupled to the lens carrier 1220, and the plurality of lenses L may be mounted on the inside of the lens barrel 1210, such that the lens barrel 1210 and the plurality of lenses L may also move in the optical axis (Z-axis) direction together with the lens carrier 1220.

The lens module 1200 may include a third driving unit 1230 that provides a driving force to move the lens carrier 1220 in the optical axis (Z-axis) direction.

The third driving unit 1230 may include a third magnet 1231 and a third coil 1233. The third magnet 1231 may be disposed on one side surface 1221a of the lens carrier 1220, and the third coil 1233 may be disposed on the housing 1010 to oppose the third magnet 1231. The third coil 1233 may be mounted on the substrate 1040.

The third magnet 1231 and the third coil 1233 may be disposed to oppose each other in the first axis (X-axis) direction. An N-pole (or an S-pole), a neutral region, and an S-pole (or an N-pole) may be sequentially disposed on one surface of the third magnet 1231, opposing the third coil 1233, in the optical axis (Z-axis) direction.

A ball member B3 (hereinafter, a third ball member) may be disposed between the lens carrier 1220 and the housing 1010. The lens carrier 1220 may be movably supported by the housing 1010 with the third ball member B3 interposed therebetween.

The third ball member B3 may include a plurality of ball members that support one side of the lens carrier 1220, and one or more ball members that support the opposite side of the lens carrier 1220. Through the third ball member B3, the lens carrier 1220 may be supported by the housing 1010 at three or more points.

The third ball member B3 may be accommodated in guide grooves (not illustrated) formed in the lens carrier 1220 and the housing 1010. The guide grooves may extend in the optical axis (Z-axis) direction, and the third ball member B3 may roll along the guide grooves to support movement of the lens carrier 1220 or the like in the optical axis (Z-axis) direction.

Movement of the lens carrier 1220 in the optical axis (Z-axis) direction may be movement relative to the housing 1010. The camera module 1000 may include a stopper 1053 disposed on the housing 1010. The stopper 1053 may prevent direct collision between insert-molded components while limiting a movement range of the lens carrier 1220 in the optical axis (Z-axis) direction.

The stopper 1053 may be disposed on the housing 1010 to oppose the lens carrier 1220 in the optical axis (Z-axis) direction. The stopper 1053 may include a damper that protrudes toward the lens carrier 1220. The lens carrier 1220 may collide with the damper, such that impact occurring upon collision may be mitigated.

The lens module 1200 may include a third position sensor 1235 that senses a position of the lens carrier 1220. The third position sensor 1235 may be mounted on the substrate 1040 together with the third coil 1233, and may be disposed on the housing 1010.

The third position sensor 1235 may be disposed to oppose the third magnet 1231 in the first axis (X-axis) direction. The third position sensor 1235 may be disposed to oppose the neutral region of the third magnet 1231. The third position sensor 1235 may be a Hall sensor, and may sense a change in a magnetic field occurring as the lens carrier 1220 or the like moves in the optical axis (Z-axis) direction, thereby sensing a position of the lens carrier 1220.

The lens carrier 1220 may be in close contact with the housing 1010 in the second axis (Y-axis) direction with the third ball member B3 interposed therebetween. A force that pulls in the second axis (Y-axis) direction may be applied to a space between the lens carrier 1220 and the housing 1010. In an example embodiment, a pulling magnet 1241 may be disposed on the lens carrier 1220. The pulling magnet 1241 may be disposed to oppose the insert member 1015, forming the bottom surface of the housing 1010, in the second axis (Y-axis) direction to generate an attractive force in the second axis (Y-axis) direction. That is, the insert member 1015 may serve as a pulling yoke.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A camera module, comprising:
a housing;
a reflective member disposed on the housing, and configured to rotate about a first rotation axis and a second rotation axis perpendicular to the first rotation axis;
a first ball member comprising a plurality of ball members disposed to be spaced apart from each other in a direction of the first rotation axis; and
a second ball member comprising a plurality of ball members disposed to be spaced apart from each other in a direction of the second rotation axis,
wherein the first ball member and the second ball member are disposed between the reflective member and the housing, and
wherein when viewed in a direction perpendicular to both the first rotation axis and the second rotation axis, the second ball member overlaps the reflective member.

2. The camera module of claim 1, wherein the reflective member has a width in a direction parallel to the first rotation axis, and a length in a direction parallel to the second rotation axis.

3. The camera module of claim 2, wherein a separation distance between the plurality of ball members in the second ball member is less than the length of the reflective member.

4. The camera module of claim 1, wherein:
the first ball member and the second ball member are disposed at different heights in a direction perpendicular to both the first rotation axis and the second rotation axis, and
the first rotation axis and the second rotation axis do not intersect each other.

5. The camera module of claim 1, further comprising:
a folded module comprising the reflective member; and
a lens module comprising a plurality of lenses disposed in an optical axis direction, and configured to move in the optical axis direction,
wherein the first rotation axis is parallel to the optical axis direction.

6. The camera module of claim 5, wherein:
the folded module further comprises:
a reflective member holder on which the reflective member is mounted; and
a rotation guide on which the reflective member holder is supported, and
the reflective member holder is supported by the rotation guide with the first ball member interposed between the reflective member holder and the rotation guide, and the rotation guide is supported by the housing with the second ball member interposed between the rotation guide and the housing.

7. The camera module of claim 6, wherein:
the folded module further comprises:
a first driving unit comprising a first magnet disposed on the reflective member holder and a first coil disposed on the housing to oppose the first magnet; and
a second driving unit comprising a second magnet disposed on the rotation guide and a second coil disposed on the housing to oppose the second magnet, and
the first coil and the second coil are mounted on a substrate and disposed on the housing.

8. The camera module of claim 7, wherein the folded module further comprises:
a first sensing magnet disposed on the reflective member holder and spaced apart from the first magnet in a direction perpendicular to both the first rotation axis and the second rotation axis; and
a second sensing magnet disposed on the rotation guide and spaced apart from the second magnet in a diagonal direction.

9. The camera module of claim 8, comprising:
a first position sensor disposed on the housing to oppose the first sensing magnet; and
a second position sensor disposed on the housing to oppose the second sensing magnet,
wherein the first position sensor and the second position sensor are mounted on the substrate together with the first coil and the second coil, and are disposed on the housing.

10. The camera module of claim 9, wherein:
the housing comprises a step portion having a step in a direction perpendicular to the optical axis direction at a first corner portion of the housing adjacent to the second sensing magnet, and at a second corner portion of the housing, which is disposed to be spaced apart from the first corner portion in a direction of the second rotation axis, and
the substrate comprises an avoidance portion having a partially cut shape at a position corresponding to the step portion.

11. A camera module, comprising:
a housing having an internal space;
a folded module disposed in the internal space and comprising a reflective member;
a lens module including a plurality of lenses arranged in an optical axis direction and disposed in the optical axis direction with respect to the folded module; and
a shield can coupled to the housing to cover the internal space,
wherein the housing and the shield can comprise a step portion having a step in a direction perpendicular to the optical axis direction, the step being disposed at one corner portion among two corner portions of the housing and the shield can adjacent to the folded module.

12. The camera module of claim 11, wherein:
the folded module comprises:
a reflective member holder on which the reflective member is mounted; and
a rotation guide on which the reflective member holder is supported, and
the reflective member holder is configured to rotate about a first rotation axis parallel to the optical axis direction, and the rotation guide is configured to rotate about a second rotation axis perpendicular to the optical axis direction.

13. The camera module of claim 12, wherein:
the folded module comprises:
a first ball member disposed between the reflective member holder and the rotation guide; and
a second ball member disposed between the rotation guide and the housing, and
the first ball member and the second ball member are disposed in a space between a reflective surface of the reflective member and a bottom surface of the housing.

14. The camera module of claim 13, wherein:
the second ball member comprises a plurality of ball members disposed to be spaced apart from each other in a direction of the second rotation axis, and
the second ball member is disposed at a position spaced apart from a center of the reflective member in a direction perpendicular to both the first rotation axis and the second rotation axis.

15. The camera module of claim 13, wherein:
the second ball member comprises a plurality of ball members disposed to be spaced apart from each other in a direction of the second rotation axis, and
a separation distance between the plurality of ball members is less than a length of the reflective member in the direction of the second rotation axis.

16. The camera module of claim 11, further comprising:
a substrate disposed to surround side surfaces of the housing,
wherein the substrate comprises an avoidance portion having a partially cut shape at a position corresponding to the step portion of the housing.
